(19) United States
(12) Patent Application Publication
(10) Pub. No.: US 2022/0124251 A1
(43) Pub. Date: Apr. 21, 2022

(54) Blind Spot Monitoring Device

(71) Applicant: Patrick Arnold, Melbourne, FL (US)

(72) Inventor: Patrick Arnold, Melbourne, FL (US)

(21) Appl. No.: 17/565,054

(22) Filed: Dec. 29, 2021

Related U.S. Application Data
(63) Continuation-in-part of application No. 17/367,292, filed on Jul. 2, 2021.
(60) Provisional application No. 63/047,780, filed on Jul. 2, 2020.

(51) Int. Cl. H04N 5/232; H04N 5/225

(52) U.S. Cl. CPC H04N 5/23299; H04N 5/2252; H04N 5/2256

(57) ABSTRACT

A blind spot monitoring device includes a housing, a chipset, a power source, a plurality of focused-beam illuminating units, a camera unit, and at least one sensor. The chipset is internally mounted within the housing, and the power source is integrated onto the housing. The plurality of focused-beam illuminating units is mounted onto the housing and functions a spotlight for the camera unit that is mounted onto the housing. The sensor is mounted onto the housing and continuously monitor the surveillances area. The chipset, the plurality of focused-beam illuminating units, the camera unit, and the sensor are electrically connected to the power source so that the blind spot monitoring device can be powered from the power source. The plurality of focused-beam illuminating units, the camera unit, and the sensor are electronically connected to the chipset so that the blind spot monitoring device can be programed and operated.

The current application is a continuation-in-part (CIP) application of a U.S. non-provisional application Ser. No. 17/367,292 filed on Jul. 2, 2021. The U.S. non-provisional application Ser. No. 17/367,292 claims a priority to a U.S. provisional application Ser. No. 63/047,780 filed on Jul. 2, 2020.

### FIELD OF THE INVENTION

The present invention relates generally to a security monitoring device and a security camera system. More specifically, the present invention relates to a multi-functional security monitoring device and a security monitoring system that includes a plurality of the security monitoring device. The present invention is specifically designed for providing effective security monitoring for residential premises. However, the present invention is not limited to this option, and it may further be adapted for different purposes.

### BACKGROUND OF THE INVENTION

Nowadays, video security systems are widely used for security monitoring and surveillance in any type of facility, in order to ward off criminals, monitor building premises, and record footage of events if necessary. A typical video security system comprises a plurality of security cameras that are located around an area, such as at each corner of a residential building. These cameras connect into a closed circuit television network that transmits the captured image data to a television monitor for real-time viewing or to a recording device (or a could server) for storage.

However, several drawbacks are associated with the existing video security systems and camera devices. For example, existing video security systems usually serve the sole purpose of monitoring a specific area. Typically, responsive to detecting unauthorized entry and/or movement at a house or business, the system generates an audible alarm and/or notify the user of the unauthorized entry and/or movement. The user cannot effectively interact with the video security system. Moreover, existing camera devices normally have a limited field of view (“FOV”) and thus cannot cover a larger area than what may be covered by the FOV. Furthermore, many camera devices are unable to identify a moving object (e.g., a person) and keep track of the moving object. The present invention aims to solve some of these problems by disclosing a smart security monitoring device and system.

### SUMMARY OF THE INVENTION

A first aspect of the present invention provides a smart security monitoring device that can be installed at a location of interest. The smart security monitoring device has a unique design such that it can provide a wider FOV. Moreover, the smart security monitoring device is provided with a plurality of light illuminators that are capable of being oriented to a moving object such that high-quality images may be captured. A second aspect of the present invention provides a security monitoring system that comprises a plurality of the smart security monitoring devices described herein.

### BRIEF DESCRIPTION OF THE DRAWINGS

FIG. 1 is a front top perspective view of the present invention.

FIG. 2 is a front bottom perspective view of the present invention.

FIG. 3 is a side view of the present invention, wherein the dash lines illustrate internally mounted components within the housing.

FIG. 4 is a back view of the present invention.

FIG. 5 is a basic schematic showing the electrical connections of the present invention.

FIG. 6 is a basic schematic showing the electronical connections of the present invention.

FIG. 7 is a front top perspective view of the present invention, showing the 360-degree rotation of the housing around the second rotational axis.

FIG. 8 is a side view of the present invention, showing the 180-degree rotation of the housing around the first rotational axis.

### DETAIL DESCRIPTIONS OF THE INVENTION

All illustrations of the drawings are for the purpose of describing selected versions of the present invention and are not intended to limit the scope of the present invention.

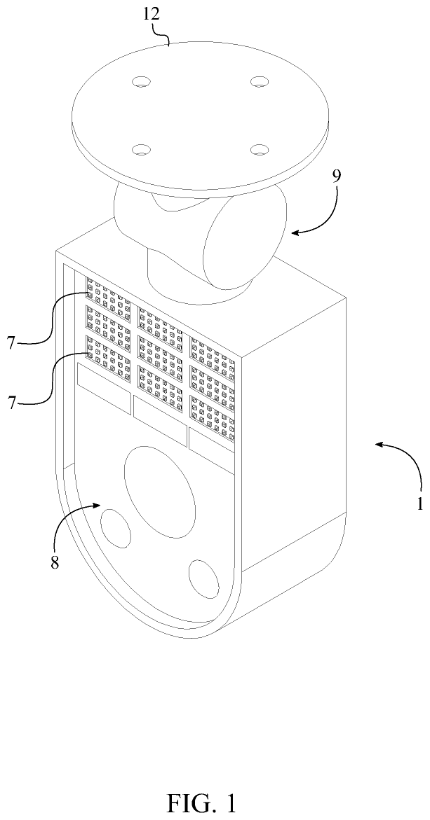

The present invention is a blind spot monitoring device that is designed for security monitoring and surveillance. It is an aim of the present invention to provide a monitoring device having a broader and deeper field of vision (FOV) and keep track of a moving object. As shown in FIGS. 1-3, the present invention comprises a housing 1, a chipset 5, a power source 6, a plurality of focused-beam illuminating units 7, a camera unit 8, and at least one sensor 13.

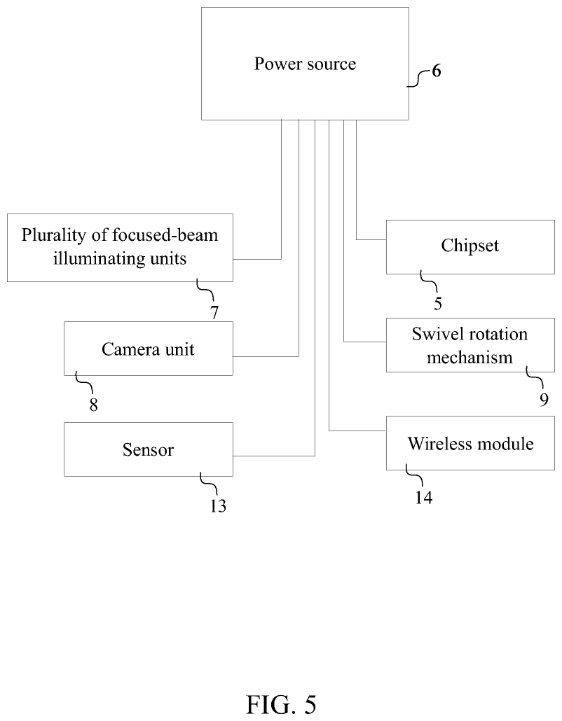

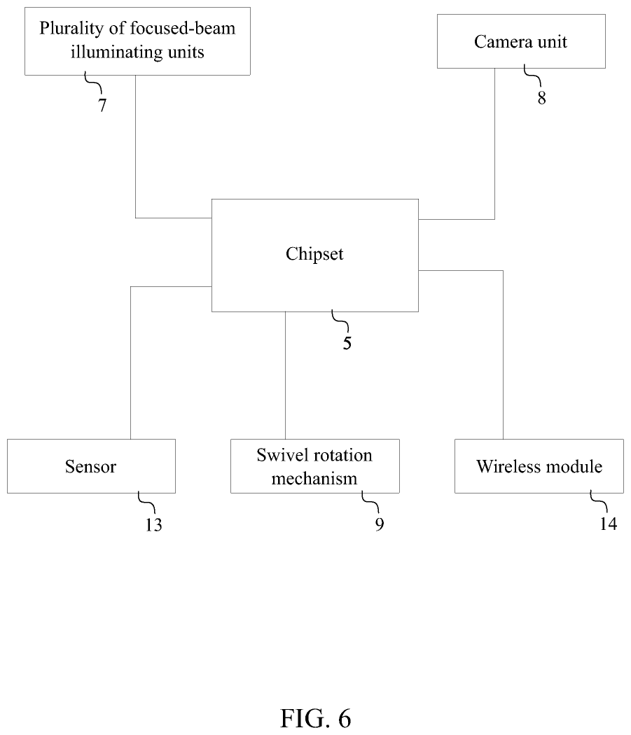

In reference to the general configuration of the present invention, as shown in FIGS. 1-3, the housing 1 functions as the main structural body so that the rest of the sub-components can be positioned in relation to the housing 1. The chipset 5 is internally mounted within the housing 1 so that the chipset 5 can receive generated signals and collected data, process the signals and data, and control the sub-components (e.g., the plurality of focused-beam illuminating units 7 and the camera unit 8) based on the received and processed signals and data. The power source 6 is integrated onto the housing 1 and enables the present invention to be electrically powered. The plurality of focused-beam illuminating units 7 is mounted onto the housing 1 so that a beam of light can be provided when necessary. The camera unit 8 is mounted onto the housing 1 to keep track of a moving object. The plurality of focused-beam illuminating units 7 and the camera unit 8 are adjacently positioned of each other to optimize the functionality of each of those components. The sensor 13 is mounted to the housing 1 so that the plurality of focused-beam illuminating units 7 and the camera unit 8 can be activated upon any types of physical occurrences that are detected through the sensor 13. In reference to FIGS. 5-6, the chipset 5, the plurality of focused-beam illuminating units 7, the camera unit 8, and the sensor 13 are electrically connected to the power source 6 so that the present invention can be electrically powered. The plurality of focused-beam illuminating units 7, the camera unit 8, and the sensor 13 are electronically connected to the chipset 5 thus allowing the chipset 5 to operate the present invention.

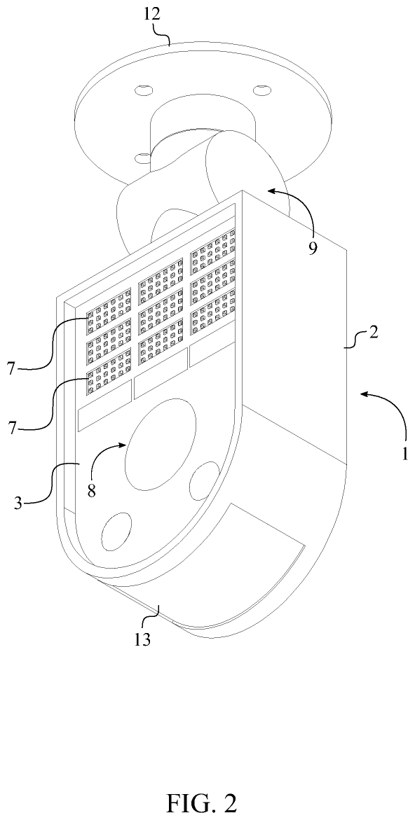

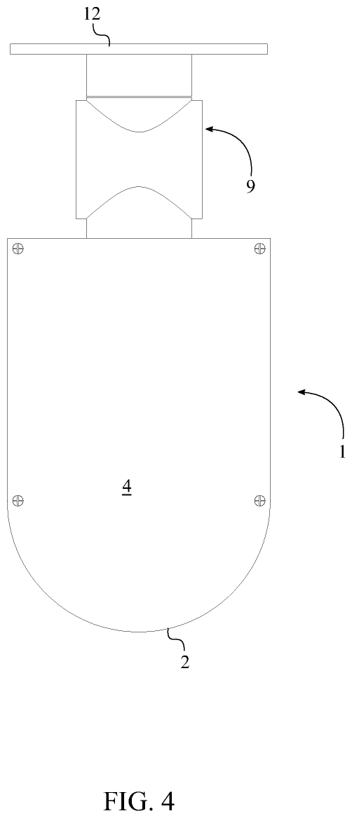

In reference to FIGS. 2-4, the housing 1 comprises a lateral panel 2, a front panel 3, and a rear panel 4. Although in the illustrated embodiment of the housing 1 is shaped into a rectangle body with a curved bottom, any other suitable shapes are also contemplated. The front panel 3 and the rear panel 4 are oppositely positioned of each other about the lateral panel 2, wherein the lateral panel 2 is perimetrically connected around the front panel 3. The rear panel 4 is mounted to the lateral panel 2 so that the internal space of the housing 1 can be easily accessed via the removal of the rear panel 4.

In reference to FIGS. 2-3 and FIGS. 5-6, the sensor 13 functions as an activation switch within the present invention. The sensor 13 can include, but is not limited to, a motion sensor, a smoke sensor, a temperature sensor, a humidity sensor, or any other industry standard sensors. Preferably the sensor 13 is mounted to the lateral panel 2 to provide a cover wider range of monitoring area. However, depending upon the type of sensor, actual location of the sensor 13 can change into the front panel 3 and/or the rear panel 4. For example, when a motion-activated sensor is utilized as the at least one sensor 13, at least two motion-activated sensors are mounted to the housing 1 for maximum coverage. Preferably, a first motion-activated sensor is mounted to the front panel 3 to cover the front-side of the present invention. A second motion-activated sensor is mounted to the rear panel 4 to cover the rear-side of the present invention. When a temperature-activated sensor is utilized as the at least one sensor 13, the temperature-activated sensor is mounted to the lateral panel 2 and a bottom end of the housing 1 for early detection of any temperature changes. Furthermore, the power source 6 is electrically connected to the sensor 13 so that the electrical current can be supplied to the sensor 13. The chipset 5 is electronically connected to the sensor 13 so that the chipset 5 is able to receive and process generated data and signals from the sensor 13.

The camera unit 8 is configured to capture images of the monitoring area of interest and preferably mounted onto the front panel 3 as shown in FIGS. 1-2 and FIGS. 5-6. As a result of the fixed connection between the front panel 3 and the lateral panel 2, the camera unit 8 is also able to provide a firm connection to the housing 1 through the front panel 3. The camera unit 8 may be visible-light digital cameras, infrared cameras, or any other suitable industry standard cameras. In the illustrated embodiment, the camera unit 8 comprises a primary camera and two secondary cameras for capturing higher-definition images. Furthermore, the power source 6 is electrically connected to the camera unit 8 so that the camera unit 8 can be electrically powered. The chipset 5 is electronically connected to the camera unit 8 so that the chipset 5 is able to receive data and signals of the camera unit 8 or upload data into the camera unit 8.

The plurality of focused-beam illuminating units 7 is configured to provide a beam of light to the monitoring area of interest and preferably mounted onto the front panel 3 as shown in FIGS. 1-2 and FIGS. 5-6. As a result of the fixed connection between the front panel 3 and the lateral panel 2, the plurality of focused-beam illuminating units 7 is also able to provide a firm connection to the housing 1 through the front panel 3. The plurality of focused-beam illuminating units 7 may be oriented to project visible light in a certain direction, such that when the plurality of focused-beam illuminating units 7 is turned on, the resulting light beams create a spotlight that tracks the moving object. Furthermore, the power source 6 is electrically connected to the plurality of focused-beam illuminating units 7 so that the plurality of focused-beam illuminating units 7 can be electrically powered. The chipset 5 is electronically connected to the plurality of focused-beam illuminating units 7 so that the chipset 5 is able to upload data into the plurality of focused-beam illuminating units 7.

The power source 6 is configured to provide electric power to the electronic components of the present invention. Preferably, the power source 6 may be a rechargeable battery that is internally mounted in between the front panel 3 and the rear panel 4. However, the power source 6 of the present invention can also be a power inlet that is powered from an external power supply.

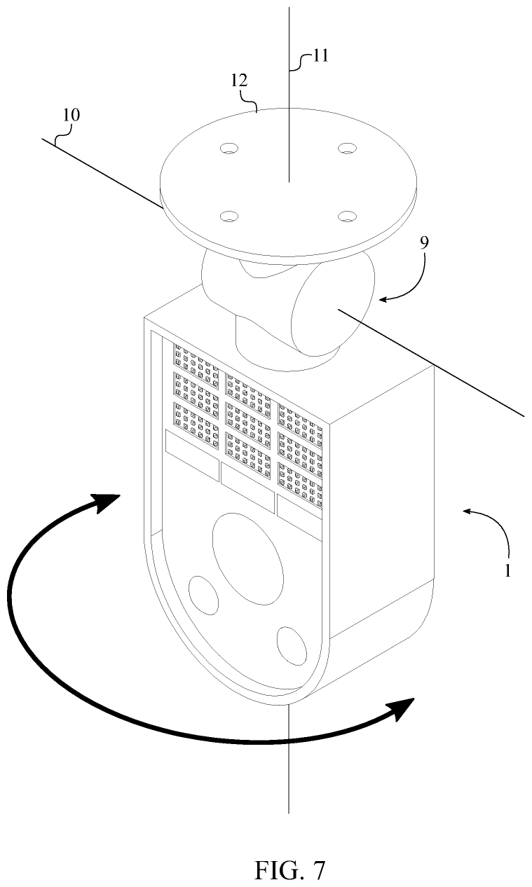

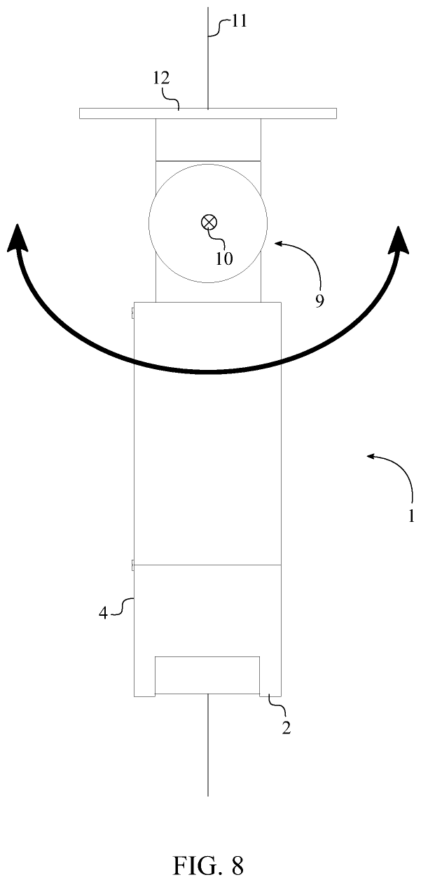

In reference to FIGS. 7-8, the present invention may further comprise a swivel rotation mechanism 9 and a mounting bracket 12 so that the housing 1 can be mounted to an existing mounting surface. The mounting bracket 12 is connected to the lateral panel 2 of the housing 1 through the swivel rotation mechanism 9 so that the housing 1 can rotate 360° horizontally and tilt 90° backward and forward. More specifically, a swivel rotation mechanism 9 comprising a first rotational axis 10 and a second rotational axis 11 as shown in FIG. 1. The first rotational axis 10 and the second rotational axis 11 provide two different rotational axis for the housing 1 to eliminate any possible blind spot within the monitoring area. In other words, mounting bracket 12 functions as the structural body that secures the housing 1 to the existing mounting surface. Once the housing 1 is mounted via the mounting bracket 12, the mounting bracket 12 maintain a stationary position. Resultantly, the housing 1 is able to radially rotate around the first rotational axis 10, wherein the housing 1 can be rotated up to 180 degrees as shown in FIG. 8. The housing 1 is also able radially rotate around the second rotational axis 11, wherein the housing 1 can rotate 360 degrees as shown in FIG. 7. Furthermore, the second rotational axis 11 concentrically traverses through the mounting bracket 12, the swivel rotation mechanism 9, and the housing 1 in such a way that the second rotational axis 11 is positioned perpendicular to a contact surface of the mounting bracket 12 that presses against the existing mounting surface. The first rotational axis 10 is positioned perpendicular to the second rotational axis 11 and traverses through the mounting bracket 12. In other words, the first rotational axis 10 centrally positioned in between the front panel 3 and the rear panel 4 and further delineates 90 degrees angle from the second rotational axis 11. The swivel rotation mechanism 9 is electrically connected to the power source 6 and electronically connected to the chipset 5 so that appropriate drive mechanisms (e.g., actuators, motors, etc.) that facilitate the rotational and tilting capabilities of the swivel rotation mechanism 9 can be electrically powered and operated.

In a preferred exemplary scenario, when an individual walks into the monitoring area, the plurality of focused-beam illuminating units 7 can follow the individual and illuminate their path as they enter or leave the monitoring area. Also, the plurality of focused-beam illuminating units 7 allows the camera unit 8 to capture sharper and clearer images. Both of these aforementioned functionalities are accomplished via the swivel rotation mechanism 9 as the housing 1 can be horizontally rotate 360 degrees and vertically rotate up to 180 degrees.

The present invention may optionally comprise a storage medium that may include one or more memory devices or electro-mechanical storage devices and associated logic (e.g., implemented in hardware, software, or a combination of both) for storing and accessing data and information (e.g., video footage) in the one or more memory or electro-mechanical storage devices. The one or more memory or electro-mechanical storage devices may include various types of volatile and non-volatile memories and storages, such as a hard disk drive, a flash memory, a RAM (Random Access Memory), an EEPROM (Electrically-Erasable Programable Read-Only Memory), and other devices for storing digital information.

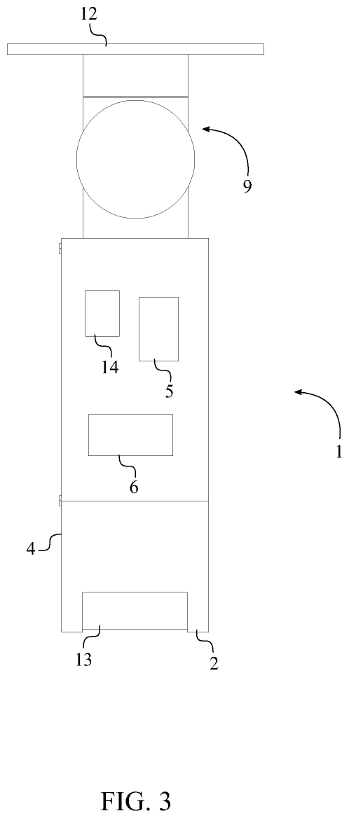

In reference to FIG. 3 and FIGS. 5-6, the present invention may further comprise a wireless module 14 that is mounted within the housing 1. The wireless module 14 is electrically connected to the power source 6 and electronically connected to the chipset 5 so that the present invention is able to wirelessly communicate with other user interface such as smartphones, electronic tablets, and a plurality of the smart security monitoring devices. The wireless module 14 is configured to interface and communicate with other external devices (e.g., servers, user devices, etc.). The wireless module 14 may be configured to support various communication standards and protocols for home networking, for camera networking, for wireless networking (e.g., the IEEE 801.11 Wi-Fi standards, the Bluetooth™ standard, the ZigBee™ standard), for general wired networking (e.g., Ethernet), and/or for other types of networking.

A user may remotely control the present invention via an app installed on his/her user interface device such as smartphones, electronic tablets, and a plurality of the smart security monitoring devices. In an exemplary scenario, the user may wirelessly link the present invention to their social media account thus allowing the present invention to access a user profile on the social media account. Furthermore, the server is configured to use facial recognition technology to identify if an intruder captured by the camera unit 8 is associated with the user profile or not. If the intruder is identified within the user profile of the social media account, a first specific alarm may be sounded to indicate that a known intruder has entered the monitoring area. If the intruder is not identified within the user profile of the social media account, a second specific alarm may be sounded to indicate that an unknown intruder has entered the monitoring area wherein the second specific alarm is different from the first specific alarm.

Although the invention has been explained in relation to its preferred embodiment, it is to be understood that many other possible modifications and variations can be made without departing from the spirit and scope of the invention as hereinafter claimed.

What is claimed is:

1. A blind spot monitoring device comprising:
a housing;
a chipset;
a power source;
a plurality of focused-beam illuminating units;
a camera unit;
at least one sensor;
the chipset being internally mounted within the housing;
the power source being integrated onto the housing;
the plurality of focused-beam illuminating units being mounted onto the housing;
the camera unit being mounted onto the housing;
the plurality of focused-beam illuminating units and the camera unit being adjacently positioned of each other;
the sensor being mounted to the housing;
the chipset, the plurality of focused-beam illuminating units, the camera unit, and the sensor being electrically connected to the power source; and
the plurality of focused-beam illuminating units, the camera unit, and the sensor being electronically connected to the chipset.

2. The blind spot monitoring device as claimed in claim 1 comprising:
the housing comprising a lateral panel, a front panel, and a rear panel;
the front panel and the rear panel being oppositely positioned of each other about the lateral panel;
the lateral panel being perimetrically connected around the front panel; and
the rear panel being mounted to the lateral panel.

3. The blind spot monitoring device as claimed in claim 2, wherein the plurality of focused-beam illuminating units is mounted onto the front panel.

4. The blind spot monitoring device as claimed in claim 2, wherein the camera unit is mounted onto the front panel.

5. The blind spot monitoring device as claimed in claim 2, wherein the power source is mounted in between the front panel and the rear panel.

6. The blind spot monitoring device as claimed in claim 1 comprising:
a swivel rotation mechanism;
a mounting bracket; and
the mounting bracket being connected to a lateral panel of the housing through the swivel rotation mechanism.

7. The blind spot monitoring device as claimed in claim 6 comprising:
a first rotational axis;
the first rotational axis traversing through the swivel rotation mechanism;
the first rotational axis being centrally positioned in between a front panel and a rear panel of the housing; and
the housing being radially rotated around the first rotational axis up to 180 degrees.

8. The blind spot monitoring device as claimed in claim 6 comprising:
a second rotational axis;
the second rotational axis concentrically traversing through the mounting bracket, the swivel rotation mechanism, and the housing; and
the housing being radially rotated around the second rotational axis up to 360 degrees.

9. The blind spot monitoring device as claimed in claim 6 comprising:
the swivel rotation mechanism being electrically connected to the power source; and
the swivel rotation mechanism being electronically connected to the chipset.

10. The blind spot monitoring device as claimed in claim 1 comprising:
a wireless module;
the wireless module being mounted within the housing;
the wireless module being electrically connected to the power source; and
the wireless module being electronically connected to the chipset.
